(19) United States
(12) Patent Application Publication
(10) Pub. No.: US 2009/0083119 A1
(43) Pub. Date: Mar. 26, 2009

(54) METHOD FOR BUSINESS PLAN OPTIMIZATION BASED ON ATTRIBUTES

(75) Inventors: Zachary James MIDED, San Francisco, CA (US); Geoffrey Alexander BOUSHEY, San Francisco, CA (US); Baruch Ismail SAEED, Berkeley, CA (US)

Correspondence Address: SUGHRUE MION, PLLC, 2100 Pennsylvania Avenue, N.W., Washington, DC, 20037, US

(73) Assignee: MAXAGER TECHNOLOGY INC., San Rafael, CA (US)

(21) Appl. No.: 11/860,473

(22) Filed: Sep. 24, 2007

(51) Int. Cl. G06Q 10/00; G06F 17/30

(52) U.S. Cl. 705/10; 705/7

(57) ABSTRACT

In a computer implemented system, business data composed of production and sales data is used to generate business plans optimized according to a plurality of attributes. The method is highly efficient in complex organizations having multiple interactive production flows, many products and/or many customers. In accordance with an embodiment of the present invention a method allowing the comparison between multiple business plans optimized according to different attributes is provided. It allows managers to make better strategic and tactical decision regarding which products to offer and which customers and markets to serve, thereby maximizing the profit the organization.

### TECHNICAL FIELD

The present invention generally relates to enterprise information systems, and more particularly, it relates to a method for optimizing business planning.

### BACKGROUND OF THE INVENTION

Increasingly, in the current competitive business climate, there is a profit driven motive to maximize the profitability of products and services (collectively referred to as “products”) that are provided or marketed to customers. Enterprises typically use business planning to make decisions in order to maximize profits.

Generally, business planning is typically the process of acquiring operational information from business units in the organization in order to create, integrate, and execute the next series of operational plans and financial budgets. The process normally entails that each logical organization of the business gathers information from logical sub-organizations, which in turn, themselves gather information from their sub-organizations, to a desired level of abstraction, usually at product, process and customer levels.

The business information is often collected from multiple data sources, such as individual spreadsheets, online transaction processing (OLTP) applications, and specialized databases, called operational data stores (ODS). The OLTP applications are enterprise systems that manage a company's basic transactions, such as supply chain management (SCM), customer relationship management (CRM), and enterprise resource planning (ERP). Using the business planning tools, managers can make decisions that allocate resources in an attempt to maximize profits. For example, key decisions include, but are not limited to, determining which new products to introduce, which suppliers to use, which capital investments to make, and what prices to charge.

In the related art, there are many tools for implementing a business planning process. Some of the conventional tools are based on linear programming models and are often inefficient and time consuming. This is due to the fact that the business planning process must be orchestrated between and across multiple organizations, each of which may have its own information tracking and planning model. To simplify their analyses, organizations typically aggregate detailed information prior to making resource allocation decisions, thereby introducing inaccuracies into the planning process and, potentially, infeasibility into the plans. Furthermore, constraints assigned to such models, such as resource availability, asset (e.g., machine) capacity availability, and maximum potential demand levels by product and by customer, may be incompatible, therefore the overall planning results are not efficiently, or otherwise globally, optimized.

Sophisticated tools for business planning are piecemeal, are aggregated and fail to capture the myriad of interconnections and tradeoffs that significantly impact the underlying economics of the business. Furthermore, such tools are not feasible for complex organizations that may have multiple business units and multiple interactive production flows. These tools may include spreadsheets, activity-based costing systems, simulation and optimization packages, and the like. Another disadvantage of conventional tools is that they cannot optimize business planning according to specific attributes (such as product and customer attributes) or combinations of attributes, thereby hindering managers' abilities to make decisions with regard to their business. For example, these decision include decisions like which product lines to offer, which products within product lines to offer, which customers should be emphasized, which markets should be served, and so on.

In view of the foregoing, it would be therefore advantageous to provide a solution which optimizes business plans of complex organizations.

### SUMMARY OF THE INVENTION

The method according to an aspect of the invention uses business data of an organization to generate business plans optimized according to a plurality of attributes. The method is highly efficient in organizations having a complex organizational structure, multiple interactive production flows, many products, and many customers. In accordance with an embodiment of the present invention a method allowing for the comparison between multiple business plans optimized according to different attributes is disclosed. It allows managers to make better strategic and tactical decisions regarding their business, thereby maximizing the profit.

### BRIEF DESCRIPTION OF THE DRAWINGS

FIG. 1 is a flowchart describing the method of generating an optimized business planning in accordance with an embodiment of the present invention.

FIG. 2 is a flowchart describing the process of optimizing according to attributes in accordance with an embodiment of the present invention.

FIGS. 3A, 3B, 3C, 3D, and 3E are exemplary tables showing the outputs generated by an embodiment of the present invention.

FIG. 4 is a flowchart describing the method for comparing between business plans disclosed in accordance with an embodiment of the present invention.

FIG. 5 is a table showing the inputs of the method for comparing between business plans.

FIGS. 6A and 6B are exemplary outputs of the method for comparing between business plans.

### DETAILED DESCRIPTION OF THE PREFERRED EMBODIMENTS

The following disclosure relates to a method for optimizing business plans using a computer. One of skill in the art would recognize that the practicalities associated with the disclosed method require a computer be used to perform the computation. A computer for the purposes of this discussion may be simply understood as a processor and an associated tangible memory storing instructions. As is well known, the instructions are performed by the processor. Thus, in other words, an embodiment of the invention resides in a tangible computer memory storing instructions for optimizing business plans, which instructions, when executed by the computer processor, enable the processor to perform certain functions as set forth below. The method is thus an automated method (although, of course, interaction with users to one degree or another is foreseen).

The method according to one embodiment uses business data of an organization (e.g., a production plant) to generate business plans optimized according to a plurality of attributes. The method is highly efficient in organizations having a complex organizational structure, multiple interactive production flows, many products, and many customers. In accordance with an embodiment of the present invention a method allowing for the comparison between multiple business plans optimized according to different attributes is disclosed. It allows managers to take better strategic and tactical decisions regarding their business, thereby maximizing the profit.

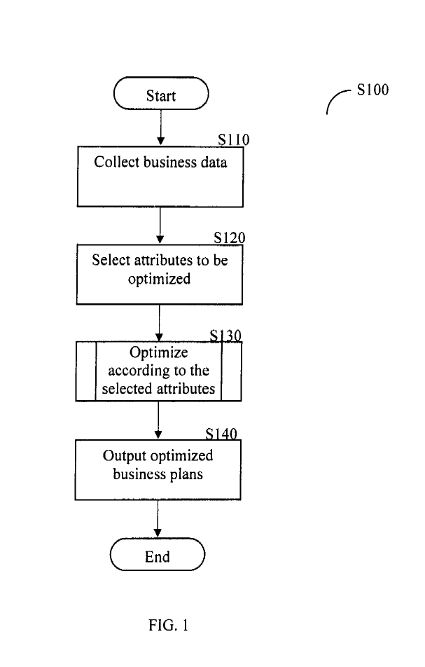

FIG. 1 shows an exemplary and non-limiting flowchart 100 describing the process of generating optimized business plans implemented in accordance with an embodiment of the present invention. At S110, business data of the organization is collected from multiple data sources, such as those described above. Specifically, the data includes finance data (e.g., production costs), marketing data (e.g., product lists, new product lists, product attributes), sales data (e.g., customer lists, new customer lists, customer attributes, sales orders, sales order attributes), and production data (e.g., asset capabilities, asset rates, routings). In an exemplary embodiment, the term, “asset” refers to a machine, the asset capability is the product types that each machine can produce, and the routing is the production sequence. A sales order includes prices and quantities by combination of product and customer. The business data may be based on historical or projected details.

At S120, the user specifies one or more attributes that may be important to optimize. The attributes are predefined and may be, but are not limited to, customer region, customer industry, customer market, sales order, deliver-to destination, product market segment, product group, product width, product gauge, sales person region, and so on. It should be noted that other types of attributes may be defined by the user and that the attributes may be different depending on the industry or business.

The selection of predefined attributes allows the optimization of a business plan by a group of attributes, where the sales order quantities with identical attribute values across a selected group of attributes are held proportionally constant. This is particularly useful for product line and customer decisions. For example, when using optimization to decide which customers to serve, the optimization allows only mix shifts between customers and does not allow mix shifts of products within each customer. This is because customers typically buy a set of products and it is not always possible to dictate the exact products that the customers would buy. Rather, it would be easier to determine to which customers to sell or not to sell to. To perform this type of optimization, the user chooses only the customer attribute, or attributes, as the attribute, or attributes, to optimize.

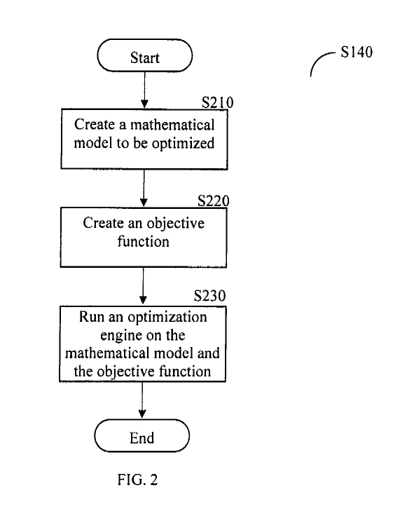

At S130, once the user completes the selections of the attributes to be optimized an optimization process is carried out. Referring now to FIG. 2, step S130 is described in greater detail. At S210 a mathematical model comprising a set of equations representing business factors, such as demand, production flow, capacity, shipping, and attribute grouping is created. It would be apparent to a person skilled in the art that the set of equations mentioned above are merely examples and other types of equations are possible.

The demand equation (s) ensure that the quantities stay within the specified minimum and maximum boundaries for each sales order. The production flow equation (s) ensure that the products are manufactured according to pre-specified steps. For example, in a paper company, products are created through a sequence of steps including fiber supply, digester, bleach plant, paper machine, finishing machine, and, finally, shipping of the products. The production flow equations check that at each step, the volumes input to the step are equal to the volumes output from the step. The production flow may be modeled in two ways: a) steps-and-transfers; and b) routes. Using the steps-and-transfers approach, individual steps are modeled, possible product transfers between steps are identified, and the abilities of specific assets at certain steps to make specific products are identified. Sequences of steps to make individual products are not pre-specified. The routes approach defines feasible sequences of steps, which are assigned to certain abilities to make specific products and each step must make the same quantity of a given product on a given route. The capacity equation (s) ensure that assets' capacities are not exceeded. For example, the sum of all products' quantities multiplied by the time per unit is smaller or equal to the asset's available capacity, as measured in total time available. The shipping equations ensure that the quantities of a product delivered equal the quantities shipped. In accordance with an embodiment of the present invention a linear program is formed from the equations mentioned in step S210. It is well known in the art that linear programming problems are ideally suited to linear equality and inequality constraints. The present method uses a set of grouping equations to create groups of selected attribute combinations and to ensure that all sales orders with the same attribute values across the group of attributes are manufactured in the same proportion of the maximum volume. Specifically, three steps are performed. First, a single group for each specific combination of the selected attributes' values is created. For example, consider a washing machine manufacturer that optimizes its business plans by grouping on the attributes “Customer Region” and “Product Group” with Region values of “North America” and “Europe”, and Product Group values of “Front Load” and “Top Load”. In this example, four groups are created: a) a group including “North America” and “Front Load”; b) a group for “Europe” and “Top Load”; c) a group for “North America” and “Top Load”; and d) a group for “Europe” and “Front Load”. Second, all sales orders are assigned to the respective created groups based on their attribute values. A sales order includes details on a customer and product with their associated attributes. A sales order may also have its own attributes, such as deliver-to location, and salesperson. Finally, the equations ensuring that all sales orders in the same group are scaled to the same proportion are created. For each sales order in a group, a constant group proportion is enforced by adding the following equation:

sales order quantity=group intensity*sales order maximum quantity; (1)

where the group intensity is the nonnegative fraction of the maximum quantity to be made for each product in the group and maximum quantity refers to the nonnegative quantity the sales order could potentially fulfill. For example, a group-intensity of 0.75 means that each sales order in the group is to be made to 75% of the maximum demand for that sales order. If the maximum demand of a sales order in that group is 100 units, then its sales order quantity would be 0.75*100=75 units. The group intensity is a decision variable determined by the optimization process; it is not an input parameter. Within a group, sales orders are manufactured in the same proportion of the maximum volume to reflect an even-handed approach to all sales orders (perhaps representing different customers) within a group. It should be noted that sales order quantities can be scaled to a midpoint between a sales order's maximum and minimum quantities. It should be further noted that the organization can use any target quantity, not just the maximum quantity. For example, the quantity actually sold from the prior planning period can be used as the target quantity.

In accordance with one embodiment of the present invention a flexibility parameter is utilized in the grouping equation (e.g., equation 1) to allow variance in the proportion produced of different sales orders quantities in the same group, and an interpolation is performed between the minimum and maximum quantities to perform grouping only on non-committed quantities (i.e., quantities already committed to customers). An exemplary equation is as follows:

sales order minimum quantity+group intensity*(1−flexibility)*(sales order maximum quantity−sales order minimum quantity)<=sales order quantity<=sales order minimum quantity+group intensity*(sales order maximum quantity−sales order minimum quantity) (2)

The flexibility parameter has a predefined value equal to or between zero and one. If the flexibility parameter is set to zero (i.e., no flexibility), then the sales order quantity equals to the group intensity multiplied by the maximum quantity, as in equation (1). If the parameter is set to one, then there is no restriction by grouping. If the flexibility parameter is between zero and one, there is some grouping restriction but also some flexibility to deviate from the group's overall percentage made. The flexibility parameter does not affect the overall model.

At S220, an objective function to measure profit is created. An exemplary and non-limiting objective function that uses cash contribution as a measure of the profit is:

cash contribution=Σ(all sales order quantities*their prices)−Σ(all sales order quantities*their costs); (3)

The prices are data associated with each sales order. The costs of products relate to specific routes, assets, shipping corridors, and so on. It should be noted that other objective functions can be used, such as revenue, quantity, profit, return on assets (ROA), and so on.

As mentioned above a linear program is formed from the equations mentioned in step S210. It is well known in the art that linear programming problems involve a linear objective function and linear equality and inequality constraints. Other mathematical programming optimization engines, such as a mixed integer-linear programming, a nonlinear programming, stochastic programming optimization engine, and the like can also be used to solve the set of equations and the objective function.

At S230, a linear programming optimization engine is executed to determine the best feasible values of the volumes and grouping parameters. That is, the optimization engine finds a set of values that satisfy the set of equations created at S210 and at the same time maximize the cash contribution measured by the objective function created at S220. It should be noted that other mathematical techniques can be utilized to form, solve and optimize the set of equations.

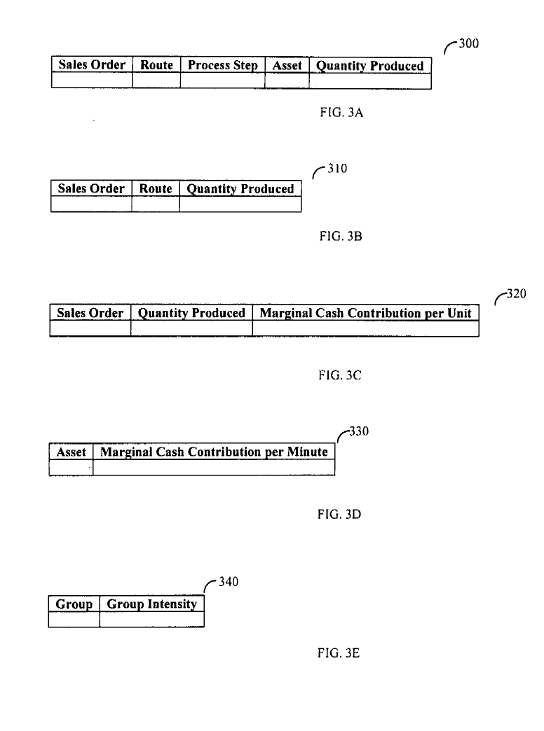

Referring back to FIG. 1, where at S140 business plans optimized according to the selected attributes are output. In accordance with an embodiment of the present invention at least an asset loading plan and a sales plan are produced. The asset loading plan defines which products to manufacture on which assets in order to gain a maximum profit. The sales plan determines at least the optimum quantity for each sales order. Specifically, as can be seen in FIGS. 3A through 3D, the outputs generated by the optimization method are arranged in four different tables: an asset loading table 300 (FIG. 3A), a route loading table 310 (FIG. 3B), a sales order marginal value table 320 (FIG. 3C), and an asset marginal value table 330 (FIG. 3D). Specifically, the asset loading table 300 includes the fields: Sales Order, Route, Process Step, Asset, and Quantity Produced. The route loading table 310 includes the fields: Sales Order, Route, and Quantity Produced. The Sales Order field includes a combination of product and customer with an associated price and a quantity. An Asset includes an optimal machine that is assigned to produce the product(s) of a sales order. A process step refers to the optimal operation in a production process needed to produce the product(s) of a sales order, and it includes one or more assets capable of performing that operation. A route is the optimal production sequence to be performed by one or more assets.

The sales order marginal value table 320 includes the fields: Sales Order, Quantity Produced, Marginal Cash Contribution per Unit. The marginal cash contribution per unit is the marginal value of selling one more unit of a sales order's product plus the marginal value of relaxing its grouping constraint by one unit.

The asset marginal value table 330 includes the following fields: Asset and Marginal Cash Contribution per Minute. The marginal cash contribution per minute for each asset is the marginal cash that could be generated with an additional time-interval “minute” of an asset time. The minute refers to the available minutes for each asset, i.e., the number of minutes that the asset was available to manufacture products. For example, in the case of an asset with 100 available minutes its respective marginal cash contribution per minute represents a 1% increase in the number of available minutes for this asset. For an asset that had 200 minutes available then marginal cash contribution per minute represents a 0.5% increase in the number of available minutes for this asset.

It would be apparent to a person skilled in the art that the tables and their content discussed can be presented in the form of charts, or any other tangible format in print, display, or otherwise.

The outputs generated by the process described herein help managers in the process of taking strategic and tactical decisions regarding products, customers, and production flows. For example, decisions about which products to provide in which quantities to which customers can be taken based on the information provided in table 320; decisions about which routes and assets to use to manufacture and to which customers to manufacture which products at which quantities can be determined based on the information provided in tables 300 and 310; decisions about the minimum attractive price for a sales order (i.e., the price of the sales order minus its marginal cash contribution per unit) can be determined based on the information provided in table 320, decisions about which attribute combinations to emphasize can be determined from the information provided in table 340, and so on.

The following is a non-limiting example, for the operation of the method described above. In a chemical manufacturer, the marketing department wishes to establish which product categories to offer and the sales department wishes to prioritize which customers to serve. The marketing department selects the “Product Group” attribute for optimization and determines that, given demand and manufacturing constraints, it is best to offer product groups P1, P4 and P5, not to offer product groups P2 and P6, and still to offer but deemphasize product group P3. Using the marginal cash contributions, the marketing department determines that product group P2 would be attractive with a 5% price increase. They revise the demand data with this price increase and lower demand quantities (as some customers will not purchase the products in the group P2 at the higher price), re-optimize, and find that it is best to offer product groups P1, P2, and P4, drop product groups P3 and P6, and deemphasize product group P5. As the price of product group P2 is now higher and was not made in the previous optimal solution, the resulting profit also increases from optimization to optimization. Therefore, the marketing department decides they cannot make any more changes to prices, thereby deciding to tentatively not to offer product groups P3 and P6. In parallel, the sales department optimizes by the “Customer” attribute and establishes which customers to serve in a manner similar to the marketing department's analysis. Once they have established their customer recommendations, the sales and marketing departments, facilitated by the finance department, work to develop a unified plan. This is performed by adjusting maximum sales quantities by product and customer, reflecting which products to potentially not to offer, for various scenarios of which products to offer and which customers to serve. At the end of the process, the sales department chooses the scenario with the maximum profitability.

In a preferred embodiment of the present invention, a method for comparing between multiple optimized business plans and scenarios is disclosed. The method further allows running different attribute optimizations on plans to be compared to determine which set of attributes generate the most profitable plan. For example, optimizing by customer versus by product may conclude that greater cash contribution is possible by varying volumes by customer and fixing the product mix provided to each customer, than by varying volumes of product but not changing the customer mix to which each product is sold.

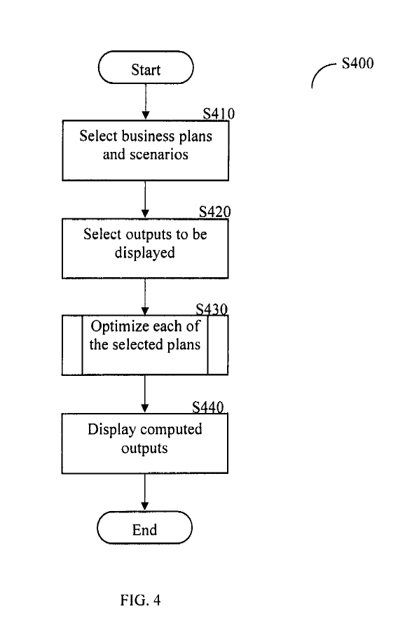

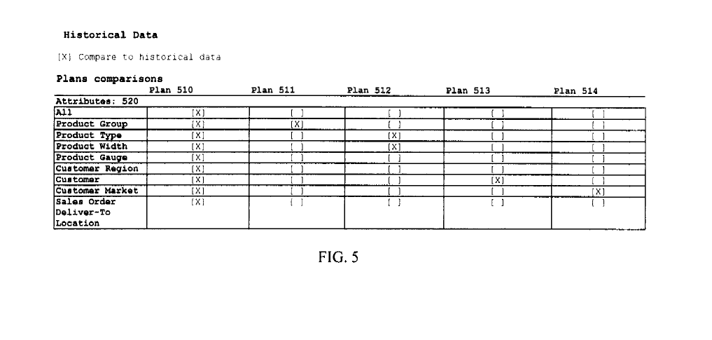

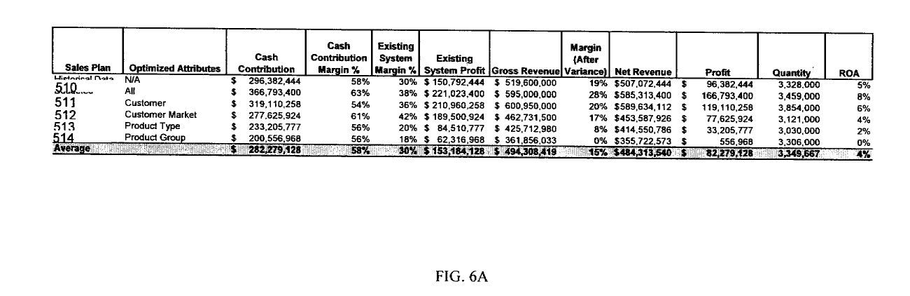

A non-limiting and exemplary flowchart 400 describing the comparison method is provided in FIG. 4. At S410, the user selects the business plans with different attribute combinations for the comparison. As an exemplary and non-limiting example, FIG. 5 shows a table that allows the optimization of different attributes to be compared with each other. In this example, five Plans 510 through 514 are provided each of which is a plan optimized according to a different set of attributes. Specifically, the Plan 510 is optimized according to all attributes listed in column 520. The Plans 511, 512, 513 and 514 are optimized according to the attributes product group, product type and width together, product width alone, customer, and customer market respectively.

At S420, the user selects the outputs to be displayed. These outputs include, but are not limited to, cash contribution, cash contribution per minute, cash contribution per unit, contribution system margin, cost per unit, existing system cost, existing system cost per unit, existing system margin, existing system profit, existing system profit per unit, gross revenue, gross revenue per minute, gross revenue per unit, margin (after variance), net assets, net revenue, net revenue per minute, net revenue per unit, operating expense, operating expense per minute, operating expense per unit, profit, profit per minute, profit per unit, quantity, return on assets (ROA), units per minute, variable cost, variable cost per unit, and so on.

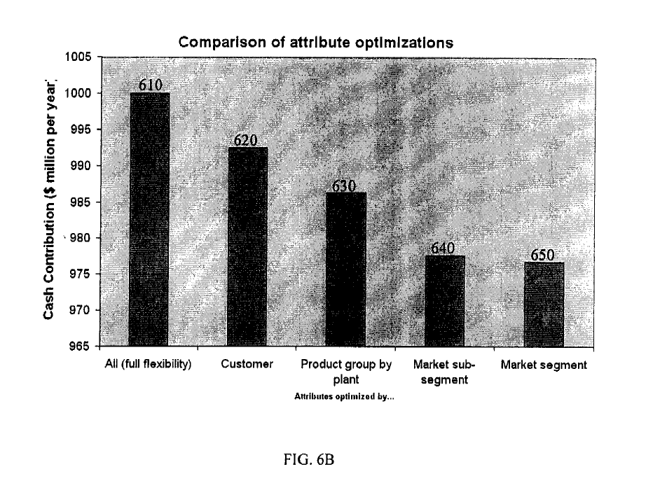

At S430, when the plans, attributes, and outputs are selected, each of Plans 510 through 514 is optimized using the process described in greater detail above. In order to reduce the execution time the plans may be optimized in parallel, or may be optimized sequentially by adjusting the same mathematical model as the only constraints that change are the attribute grouping constraints. At S440, the generated data according to the selected outputs are displayed to the user. The data generated by the comparison method can be displayed in the form of tables or charts. For example, FIG. 6A shows the outputs: cash contribution, cash contribution margin, existing system margin, existing system profits, gross revenue, net revenue, quantity, and ROA for each of the Plans 510 through 514. A chart showing that the cash contribution per year of each of the plans is provided in FIG. 6B. Specifically, bar 610 shows the contribution of the plan optimized according to “All” attributes, bar 620 is the contribution of the plan optimized according to “Customer” attribute, bar 630 is the contribution of the plan optimized according to “Product Group by Plant” attribute, bar 640 is the contribution of the plan optimized according to “Market Sub-Segment” attribute, and the bar 640 is the contribution of the plan optimized according to “Market Segment” attribute. The optimization of each plan according to the attributes is as described in detail above.

It should be noted that the methods and processes described herein can be implemented in software, hardware, firmware or any combination thereof.

There is claimed:

1. A method for generating an optimized business plan, comprising:
collecting business data of an organization;
selecting at least one attribute to optimize;
optimizing the business plan according to the at least one selected attribute; and
outputting the optimized business plan.

2. The method of claim 1, wherein the business plan comprises at least one of: a sales plan and an asset loading plan.

3. The method of claim 1, wherein the business data comprises at least one of: finance data, marketing data, sales data, and production data.

4. The method of claim 3, wherein the business data is based on at least one of: historical details and projected details.

5. The method of claim 3, wherein the business data is collocated from a plurality of resources including at least one of: spreadsheets, flat files, online transaction processing (OLTP) applications, and operational data stores (ODS).

6. The method of claim 1, wherein the at least one attribute comprises at least one of: customer, customer region, customer industry, customer market, sales orders, deliver-to destination, product, product market segment, product group, and sales person.

7. The method of claim 6, wherein the at least one attribute is predefined.

8. The method of claim 1, wherein optimizing the business plan according to the at least one selected attribute further comprises:
creating a mathematical model, the mathematical model comprising a set of equations
representing a plurality of business factors, wherein the plurality of business factors
comprises at least an attribute grouping;
creating an objective function; and
determining a set of values that satisfy the set of equations and maximize the objective function.

9. The method of claim 8, wherein determining the set of values that satisfy the set of equations and maximize the objective function is performed using a mathematical programming optimization engine, wherein the mathematical programming optimization engine comprises at least one of: a linear programming optimization engine, a mixed integer-linear programming optimization engine, a quadratic programming optimization engine, a nonlinear programming optimization engine, and a stochastic programming optimization engine.

10. The method of claim 8, wherein the plurality of business factors further comprises at least one of: demand, production flow, capacity, and shipping.

11. The method of claim 10, wherein an attribute grouping equation is used to ensure that all sales orders with the same attribute values across the group of attributes are manufactured in the same proportion of the maximum volume.

12. The method of claim 11, wherein the objective function maximizes at least the profit.

13. The method of claim 2, wherein outputting the optimized business plan further comprising: producing at least one of the following outputs: an asset loading table, a route loading table, a sales order marginal value table, and an asset marginal value table.

14. The method of claim 13, wherein the outputs are displayed or printed.

15. The method of claim 2, wherein the optimized business plan allows managers to take business decisions regarding products, customers, and production flows.

16. A computer program product for generating an optimized business plan, the computer program product having computer instructions on a tangible computer readable medium, the instructions being adapted to enable a computer system to perform operations comprising:
collecting business data of an organization;
selecting at least one attribute to optimize;
optimizing the business plan according to the at least one selected attribute; and
outputting the optimized business plan.

17. The computer program product of claim 16, wherein the business plan comprises at least one of: a sales plan and an asset loading plan.

18. The computer program product of claim 17, wherein the outputs are displayed or printed.

19. A method for comparing between multiple optimized business plans, comprising:
selecting a plurality of business plans and a plurality of attribute combinations to be optimized;
selecting at least one output to be generated;
optimizing each of the selected business plans according to their respective selected attributes; and
generating a result respective to the selected output.

20. The method of claim 19, the output to be generated comprises at least one of: cash contribution, cash contribution per minute, cash contribution per unit, contribution system margin, cost per unit, existing system cost, existing system cost per unit, existing system margin, existing system profit, existing system profit per unit, gross revenue, gross revenue per minute, gross revenue per unit, margin, net assets, net revenue, net revenue per minute, net revenue per unit, operating expense, operating expense per minute, operating expense per unit, profit, profit per minute, profit per unit, quantity, return on assets (ROA), units per minute, variable cost, and variable cost per unit.

21. The method of claim 19, wherein the business plans comprise at least one of: a sales plan and an asset loading plan.

22. The method of claim 19, wherein the generated output result is displayed or printed.

23. The method of claim 19, wherein the optimized business plan allows managers to take business decisions regarding products, customers, and production flows.

24. A computer program product for comparing between multiple optimized business plans, the computer program product having computer instructions on a tangible computer readable medium, the instructions being adapted to enable a computer system executing the instructions to perform operations comprising:
selecting a plurality of business plans and a plurality of attribute combinations to be optimized;
selecting at least one output to be generated;
optimizing each of the selected business plans according to their respective selected attribute; and
generating a result respective to the selected output.

25. The computer program product of claim 24, wherein the generated output result is displayed or printed.
